(19) United States
(12) Patent Application Publication
(10) Pub. No.: US 2014/0019078 A1
(43) Pub. Date: Jan. 16, 2014

(54) Coke Drum Analysis Apparatus and Method

(71) Applicants: Toshiya YAMAMOTO, Saijo-shi (JP); HUHETAOLI, Guangzhou-city (CN); Shinta NIIMOTO, Niihama-shi (JP); Mitsuru OOHATA, Osaka (JP); Tetsuya TAGAWA, Osaka (JP); Fumiyoshi MINAMI, Osaka (JP)

(72) Inventors: Toshiya YAMAMOTO, Saijo-shi (JP); HUHETAOLI, Guangzhou-city (CN); Shinta NIIMOTO, Niihama-shi (JP); Mitsuru OOHATA, Osaka (JP); Tetsuya TAGAWA, Osaka (JP); Fumiyoshi MINAMI, Osaka (JP)

(73) Assignee: Sumitomo Heavy Industries Process Equipment Co., Ltd., Saijo-shi (JP)

(21) Appl. No.: 13/545,462

(22) Filed: Jul. 10, 2012

(51) Int. Cl. G01K 13/00; G06F 19/00

(52) U.S. Cl. 702/104; 702/136

(57) ABSTRACT

Provided is a coke drum analysis apparatus and method, in which a thickness of coke adhering to an inner surface of a sidewall portion of a coke drum is calculated based on change in a temperature of an outer surface of the sidewall portion and a water level ascent velocity of quenching water, and change in a temperature of the inner surface of the sidewall portion is calculated based on the water level ascent velocity and the calculated thickness of the coke.

### TECHNICAL FIELD

The present invention relates to a coke drum analysis apparatus and method for analyzing change in a sidewall portion of a coke drum having a cylindrical shape.

### BACKGROUND ART

Conventionally, as apparatuses used for an oil refining process, coke drums having a cylindrical shape are known (see, for example, Patent Document 1). When manufacturing intended products, heated raw oil is charged into a coke drum and quenching water is charged into the coke drum. Thus, the temperature of the coke drum changes in a range of approximately 50° C. to 500° C.

### PRIOR ART DOCUMENT(S)

### Patent Document(s)

Patent Document 1: WO2011/045843

The coke drum is repeatedly operated with the temperature changing between approximately 50° C. and 500° C., resulting in damage due to fatigue in a sidewall portion of the coke drum. Therefore, it is desired to install measuring devices on an inner surface of the sidewall portion, which is vulnerable to damage due to fatigue; however, inside of the coke drum, produced coke is fractured by high-pressure water so as to fly part, and thus, measuring devices cannot be installed on the inner surface of the sidewall portion. Accordingly, the status (temperature, strain and the like) of the inner surface of the sidewall portion cannot be measured.

Therefore, conventionally, measuring devices are installed on an outer surface of the sidewall portion to measure the status (temperature, strain and the like) of the outer surface of the sidewall portion. Then, based on an assumption that the inner surface of the sidewall portion is in the same status (temperature, strain and the like) as those of the outer surface of the sidewall portion, fatigue damage in the inner surface of the sidewall portion is estimated. Thus, the estimation of fatigue damage in the inner surface of the sidewall portion has poor accuracy.

### SUMMARY OF THE INVENTION

Therefore, in view of the forementioned circumstances, an object of the present invention is to provide a coke drum analysis apparatus and method that can improve the accuracy of the estimation of fatigue damage in a sidewall portion of a coke drum.

According to the present invention, there is provided a coke drum analysis apparatus for analyzing change in a sidewall portion of a coke drum having a cylindrical shape, the apparatus including:

a temperature detecting section that detects a temperature of an outer surface of the sidewall portion;

a water level detecting section that detects a water level ascent velocity of quenching water supplied into the coke drum;

a thickness calculating section that calculates a thickness of coke adhering to an inner surface of the sidewall portion based on change in the temperature of the outer surface of the sidewall portion detected by the temperature detecting section and the water level ascent velocity of the quenching water detected by the water level detecting section; and

a temperature calculating section that calculates change in a temperature of the inner surface of the sidewall portion quenched by the quenching water, based on the water level ascent velocity detected by the water level detecting section and the thickness of the coke calculated by the thickness calculating section.

According to the present invention, the temperature detecting section detects a temperature of an outer surface of a sidewall portion of a coke drum. The water level detecting section detects a water level ascent velocity of quenching water supplied into the coke drum. The thickness calculating section calculates a thickness of coke adhering to an inner surface of the sidewall portion, based on change in the temperature of the outer surface of the sidewall portion detected by the temperature detecting section and the water level ascent velocity of the quenching water detected by the water level detecting section. The temperature calculating section calculates change in a temperature of the inner surface of the sidewall portion, based on the water level ascent velocity detected by the water level detecting section and the thickness of the coke calculated by the thickness calculating section. Therefore, data on the calculated change in the temperature of the inner surface is highly-accurate analysis data taking into account the thickness of the coke (as the thickness is larger, a decrease in the temperature of the inner surface is slower) and the water level ascent velocity of the quenching water (as the water level ascent velocity is higher, a decrease in the temperature of the inner surface is faster).

Also, the coke drum analysis apparatus according to the present invention may have a configuration in which:

the temperature detecting section includes a plurality of temperature measuring devices that each measures a temperature of the outer surface of the sidewall portion;

the plurality of temperature measuring devices measure temperatures at positions of the outer surface of the sidewall portion, the positions being spaced from each other in a height direction of the coke drum; and

the water level detecting section includes an ascent velocity calculating section that calculates the water level ascent velocity of the quenching water based on a difference between times at which the temperatures measured by the respective temperature measuring devices started decreasing.

Also, the coke drum analysis apparatus according to the present invention may have a configuration in which:

the plurality of temperature measuring devices measure temperatures at positions of the outer surface of the sidewall portion, the positions being at a same height position of the coke drum and being spaced from each other in a circumferential direction of the coke drum; and

the water level detecting section includes an arrival time calculating section that calculates a time at which the quenching water arrived at the height position, based on the times when the temperatures measured by the respective temperature measuring devices started decreasing.

Also, the coke drum analysis apparatus according to the present invention may have a configuration in which:

the temperature calculating section divides the sidewall portion into a plurality of divisions in a thickness direction and the height direction, respectively, and calculates change in a temperature of each division of the sidewall portion.

Also, the coke drum analysis apparatus according to the present invention may further include:

a strain calculating device that calculates a strain in the inner surface of the sidewall portion based on the change in the temperature of the inner surface of the sidewall portion calculated by the temperature calculating section.

Also, the coke drum analysis apparatus according to the present invention may further include:

a strain measuring device that measures a strain at a predetermined position in the outer surface of the sidewall portion, a temperature at the predetermined position of the outer surface being detected by the temperature detecting section; and

a data correction section that corrects data on the strain in the inner surface calculated by the strain calculating device,

wherein the strain calculating device calculates a strain at the predetermined position in the outer surface, based on change in the temperature at the predetermined position of the outer surface detected by the temperature detecting section; and

wherein the data correction section corrects the data on the strain in the inner surface calculated by the strain calculating device, based on data on the strain at the predetermined position in the outer surface measured by the strain measuring device and data on the strain at the predetermined position in the outer surface calculated by the strain calculating device.

Also, the coke drum analysis apparatus according to the present invention may further include:

a strain measuring device that measures a strain at a predetermined position in the outer surface of the sidewall portion; and

a data correction section that corrects data on the strain in the inner surface calculated by the strain calculating device,

wherein the temperature calculating section calculates change in a temperature at the predetermined position of the outer surface of the sidewall portion;

wherein the strain calculating device calculates a strain at the predetermined position in the outer surface, based on the change in the temperature at the predetermined position of the outer surface calculated by the temperature calculating section; and

wherein the data correction section corrects data on the strain in the inner surface calculated by the strain calculating device, based on data on the strain at the predetermined position in the outer surface measured by the strain measuring device and data on the strain at the predetermined position in the outer surface calculated by the strain calculating device.

According to another aspect of the present invention, there is provided a coke drum analysis method for analyzing change in a sidewall portion of a coke drum having a cylindrical shape, the method including:

detecting a temperature of an outer surface of the sidewall portion;

detecting a water level ascent velocity of quenching water supplied into the coke drum;

calculating a thickness of coke adhering to an inner surface of the sidewall portion based on change in the detected temperature of the outer surface of the sidewall portion and the detected water level ascent velocity of the quenching water; and

calculating change in a temperature of the inner surface of the sidewall portion quenched by the quenching water, based on the detected water level ascent velocity of the quenching water and the calculated thickness of the coke.

As described above, the present invention enables obtainment of highly-accurate data on change in a temperature of an inner surface, and thus, exhibits an excellent effect of enhancing the accuracy of estimation of fatigue damage in a sidewall portion of a coke drum.

### BRIEF DESCRIPTION OF THE DRAWINGS

FIG. 1 is an overall cross-sectional view of the coke drum to be analyzed by an analysis apparatus according to an embodiment of the present invention;

FIG. 2 is an overall cross-sectional view of the coke drum to be analyzed by the analysis apparatus according to the embodiment;

FIG. 3 is a schematic system overview of the analysis apparatus according to the embodiment;

FIG. 4 is a front view of a main part of a coke drum on which respective measuring devices in the analysis apparatus according to the embodiment are installed;

FIG. 5 is a diagram illustrating an analysis method according to the embodiment, which is a graph indicating temperature changes according to different thicknesses of adhered coke;

FIG. 6 is a cross-sectional view of a main part of a coke drum for illustrating the analysis method according to the embodiment;

FIG. 7 is a diagram illustrating the analysis method according to the embodiment, which is a graph indicating temperature changes according to different water level ascent velocities;

FIG. 8 is a flowchart illustrating the analysis method according to the embodiment;

FIG. 9 is a schematic system overview of an analysis apparatus according to another embodiment of the present invention;

FIG. 10 is a flowchart illustrating an analysis method according to the embodiment; and

FIG. 11 is a front view of a main part of a coke drum on which respective measuring devices in an analysis apparatus according to still another embodiment of the present invention are installed.

### DETAILED DESCRIPTION OF THE PREFERRED EMBODIMENTS

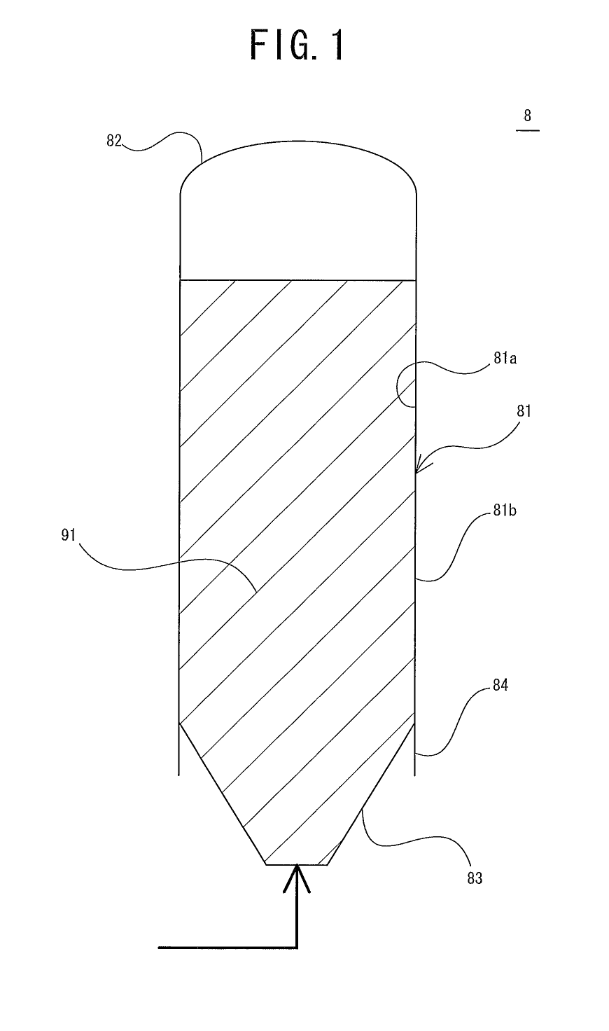

Hereinafter, a coke drum analysis apparatus according to an embodiment of the present invention will be described with reference to FIGS. 1 to 8. Prior to description of respective components of the coke drum analysis apparatus according to the present embodiment (hereinafter also simply referred to “analysis apparatus”), a coke drum, which is an object to be analyzed, will be described.

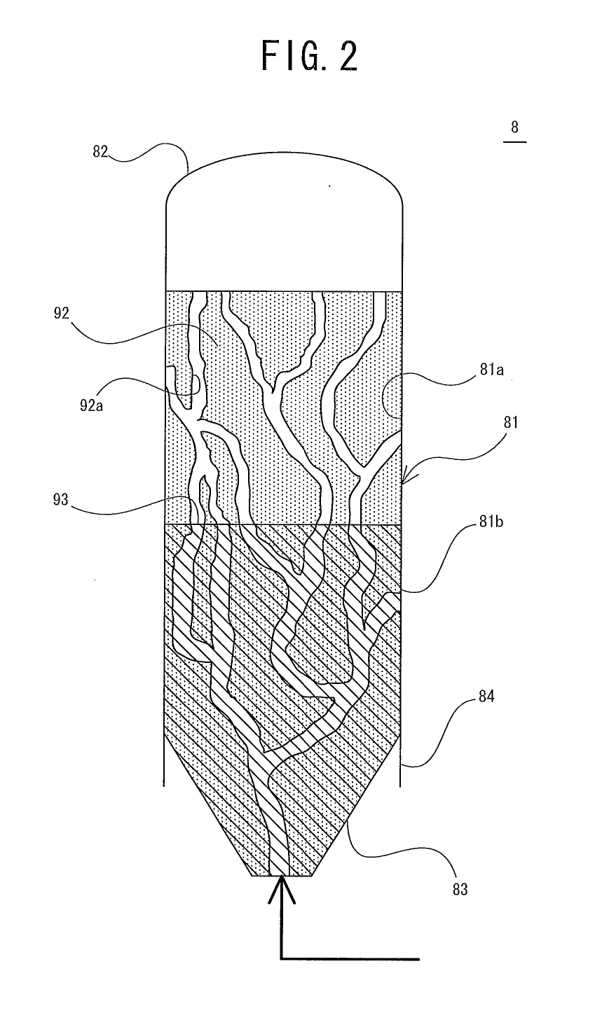

As illustrated in FIGS. 1 and 2, a coke drum 8 includes a sidewall portion 81 having a cylindrical shape, a top wall portion 82 connected to an upper portion of the sidewall portion 81, a bottom wall portion 83 connected to a lower portion of the sidewall portion 81, and a cylindrical supporting portion (skirt) 84 that supports the lower portion of the sidewall portion 81. The coke drum 8 is formed of carbon steel or chrome molybdenum steel.

In the oil refining process using the coke drum 8, as illustrated in FIG. 1, raw oil 91 heated to approximately 450° C. to 500° C. is first charged into the coke drum 8. As a result of the raw oil 91 repeating a thermal cracking reaction, as illustrated in FIG. 2, coke 92 is gradually produced inside the coke drum 8.

Then, steam is sent into the coke drum 8, and thereby volatile components are removed. Subsequently, quenching water 93 is poured into the coke drum 8, and the ascending quenching water 93 gradually quenches the coke 92 and the coke drum 8. At this time, water channels 92a are formed in the coke 92 by the steam and the quenching water 93, and thus, the thickness of the coke 92 adhering to an inner surface 81a of the sidewall portion 81 is not uniform.

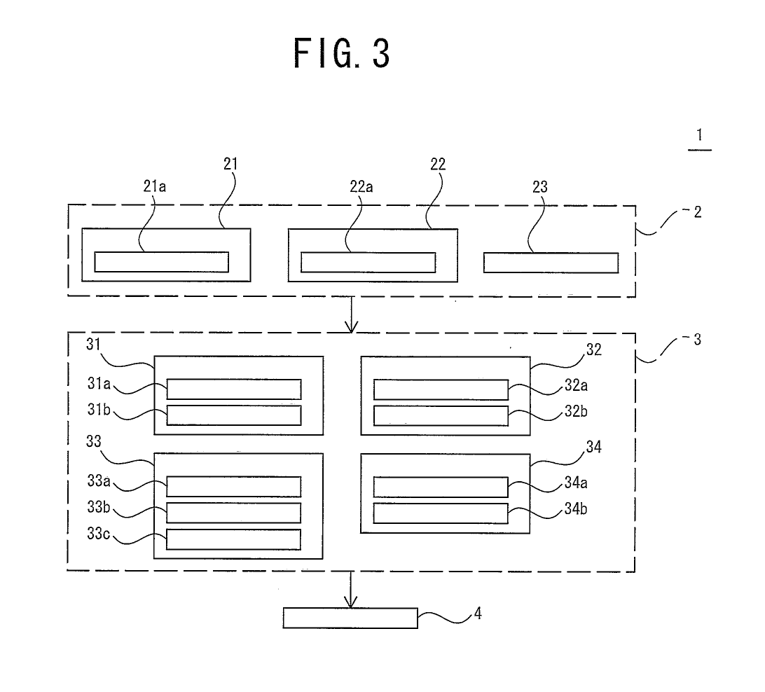

As illustrated in FIG. 3, an analysis apparatus 1 according to the present embodiment is to analyze change in the sidewall portion 81 of the coke drum 8. The analysis apparatus 1 includes an input device 2 for inputting data for analysis, a processor 3 that processes the input data, and an output device 4 that outputs the processed data, such as a display device or a printer, for example.

The input device 2 includes a temperature detecting section 21 that detects a temperature of an outer surface 81b of the sidewall portion 81, a strain detecting section 22 that detects a strain in the outer surface 81b of the sidewall portion 81, and an input section 23, for example, a keyboard or a mouse, for inputting various types of data that are factors for analysis (e.g., a heating temperature of the raw oil 91, a thickness of the sidewall portion 81 and/or a material of the sidewall portion 81).

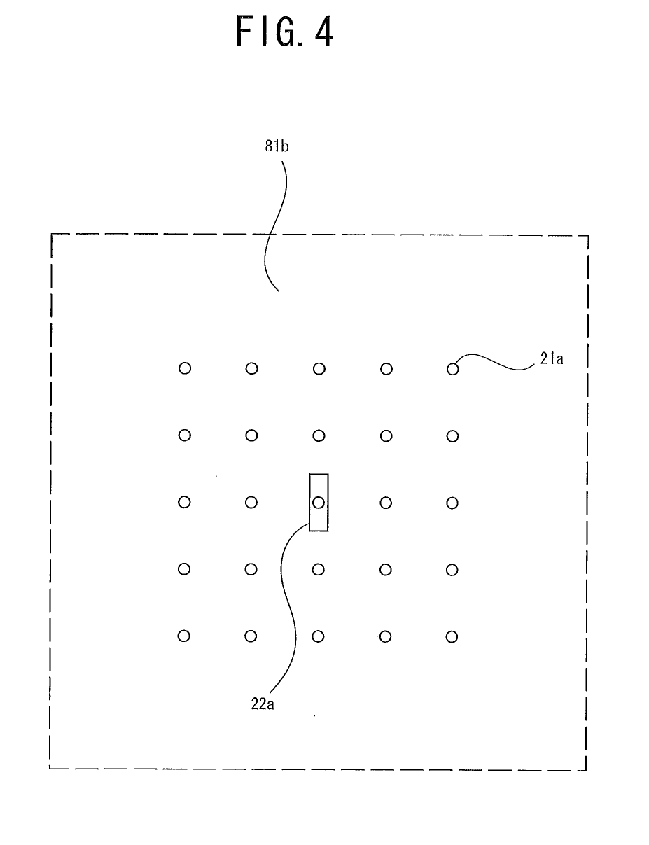

As illustrated in FIG. 4, the temperature detecting section 21 includes a plurality of temperature measuring devices 21a that each measures a temperature of the outer surface 81b of the sidewall portion 81.

The temperature measuring devices 21a measure temperatures at height different positions of the outer surface 81b of the sidewall portion 81, the height different positions being spaced from each other in a height direction of the coke drum 8, and also measure temperatures at circumferentially different positions of the outer surface 81b of the sidewall portion 81, the circumferentially different positions being at a same height position and being spaced from each other in a circumferential direction of the coke drum 8. In the present embodiment, five temperature measuring devices 21a are arranged in the height direction and five temperature measuring devices 21a are arranged also in the circumferential direction so that the respective temperature measuring devices 21a are arranged at regular intervals (60 cm). In the present embodiment, the temperature measuring devices 21a each include a temperature sensor (thermocouple) that is secured to the outer surface 81b of the sidewall portion 81 and thereby outputs an electrical signal representing an amount of change in the temperature of the outer surface 81b of the sidewall portion 81. It should be understood that, e.g., a count, an arrangement and a sensor type of the temperature measuring device 21a are not limited to those in the above-described configuration.

The strain detecting section 22 includes a strain measuring device 22a that measures a strain in the outer surface 81b of the sidewall portion 81.

In the present embodiment, the strain measuring device 22a is disposed on the outer surface 81b of the sidewall portion 81 at a position that is the same as the position of a temperature measuring device 21a in a center in the height direction and the circumferential direction. In the present embodiment, the strain measuring device 22a includes a dynamic sensor (strain gauge) that is secured to the outer surface 81b of the sidewall portion 81 and thereby outputs an electrical signal representing a strain that is a minute amount of mechanical change (expansion/contraction) in the outer surface 81b of the sidewall portion 81. It should be understood that, e.g., a count, an arrangement and a sensor type of the strain measuring device 22a is not limited to those in the above-described configuration.

Referring back to FIG. 3, the processor 3 includes a water level detecting section 31 that detects a water level ascent velocity of the quenching water 93 supplied into the coke drum 8, a thickness calculating section 32 that calculates a thickness of the coke 92 adhering to the inner surface 81a of the sidewall portion 81, a temperature calculating section 33 that calculates change in a temperature of the sidewall portion 81, and a strain calculating device 34 that calculates a strain in the inner surface 81a of the sidewall portion 81.

The water level detecting section 31 includes an arrival time calculating section 31a that calculates a time at which the quenching water 93 arrived at a predetermined position, and an ascent velocity calculating section 31b that calculates a water level ascent velocity of the quenching water 93.

The arrival time calculating section 31a performs calculation to average times at which the temperatures measured by the respective temperature measuring devices 21a arranged at positions that are the same in the height direction and spaced from each other in the circumferential direction of the coke drum 8 started decreasing and set the resulting average time as a time at which the quenching water 93 arrived at such height position.

The ascent velocity calculating section 31b calculates a water level ascent velocity of the quenching water 93 based on a difference between the quenching water arrival times at the respective height positions calculated by the arrival time calculating section 31a, and distances between the respective height positions.

The thickness calculating section 32 includes a thickness information storing section 32a that stores information on a thickness of the coke 92, and a thickness determining section 32b that determines a thickness of the coke 92 adhering to the inner surface 81a of the sidewall portion 81 based on the information in the thickness information storing section 32a.

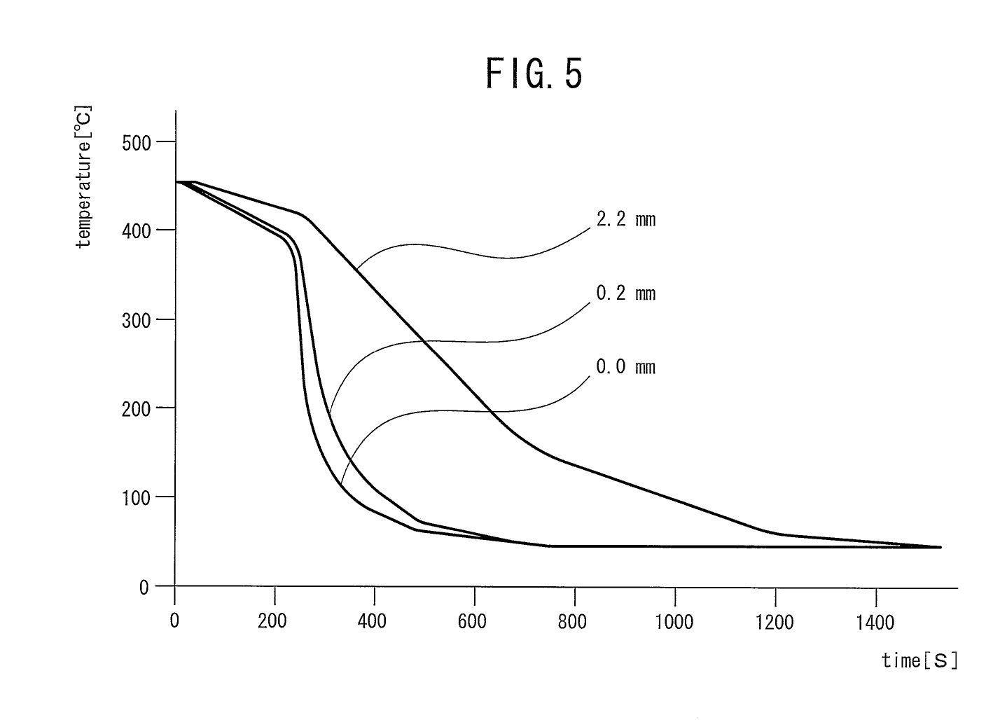

The thickness information storing section 32a stores information on a relationship among change in the temperature of the outer surface 81b of the sidewall portion 81, the water level ascent velocity of the quenching water 93, and the thickness of the coke 92 adhering to the inner surface 81a of the sidewall portion 81 corresponding thereto. The thickness information storing section 32a stores relationship information for various conditions (for example, in addition to a temperature of the outer surface 81b immediately before quenching, a temperature decrease velocity of the outer surface 81b and the water level ascent velocity of the quenching water 93, the thickness of the sidewall portion 81 and/or the material of the sidewall portion 81), based on the results of experiments and calculation results obtained from the experiments results. As illustrated in FIG. 5, the change in the temperature of the outer surface 81b and the thickness of the coke 92 adhering to the inner surface 81a are in a relationship that as the thickness of the coke 92 is larger, the change in the temperature (temperature decrease velocity) of the outer surface 81b is slower. The graph illustrated in FIG. 5 indicates change in the temperature of the outer surface 81b in each of cases where the water level ascent velocity is 5.0 mm/s and the thickness of the coke 92 is 0.0 mm, 0.2 mm and 2.2 mm, respectively.

The thickness determining section 32b determines the thickness of the coke 92 adhering to the inner surface 81a of the sidewall portion 81, based on the change in the temperature of the outer surface 81b of the sidewall portion 81 measured by each temperature measuring device 21a, the water level ascent velocity of the quenching water 93 calculated by the ascent velocity calculating section 31b, and information stored in the thickness information storing section 32a.

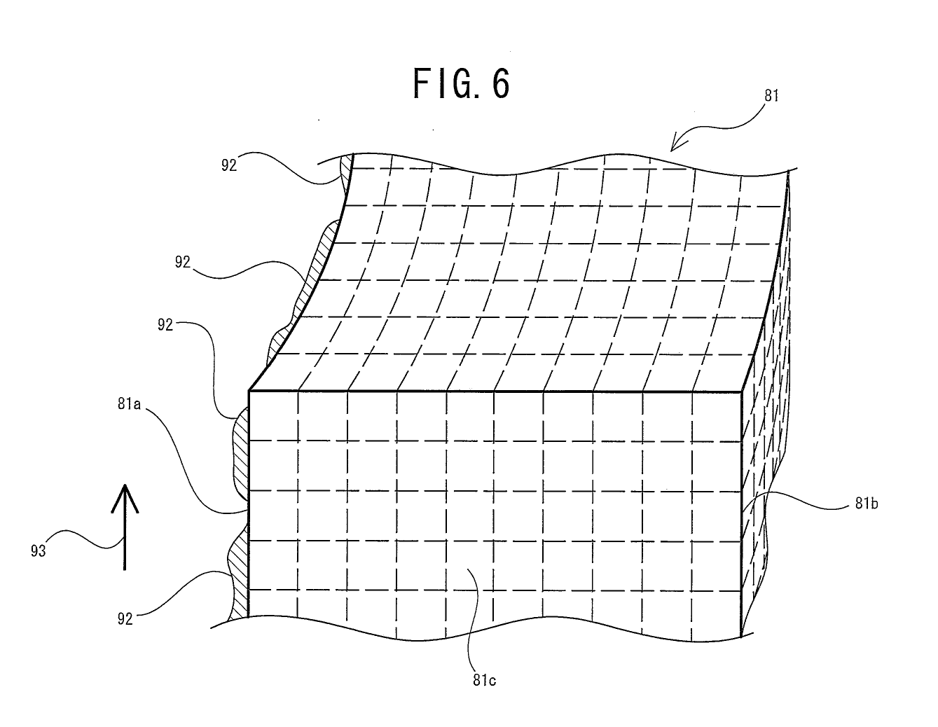

Referring back to FIG. 3, the temperature calculating section 33 includes a sidewall dividing section 33a that divides the sidewall portion 81 into divisions 81c each having a predetermined size (see FIG. 6), a temperature information storing section 33b that stores information on change in the temperature of the sidewall portion 81, and a temperature change calculating section 33c that calculates change in a temperature of each division 81c of the sidewall portion 81 divided based on the information in the temperature information storing section 33b.

As illustrated in FIG. 6, the sidewall dividing section 33a divides the sidewall portion 81 into a plurality of divisions in a thickness direction and the height direction, respectively. In the present embodiment, the divisions 81c result from dividing the sidewall portion 81 having a thickness of approximately 40 to 50 mm into ten parts each having a cube shape of approximately 4 to 5 mm. It should be understood that the size and the count of the divisions 81c are not limited to those in the above-described configuration.

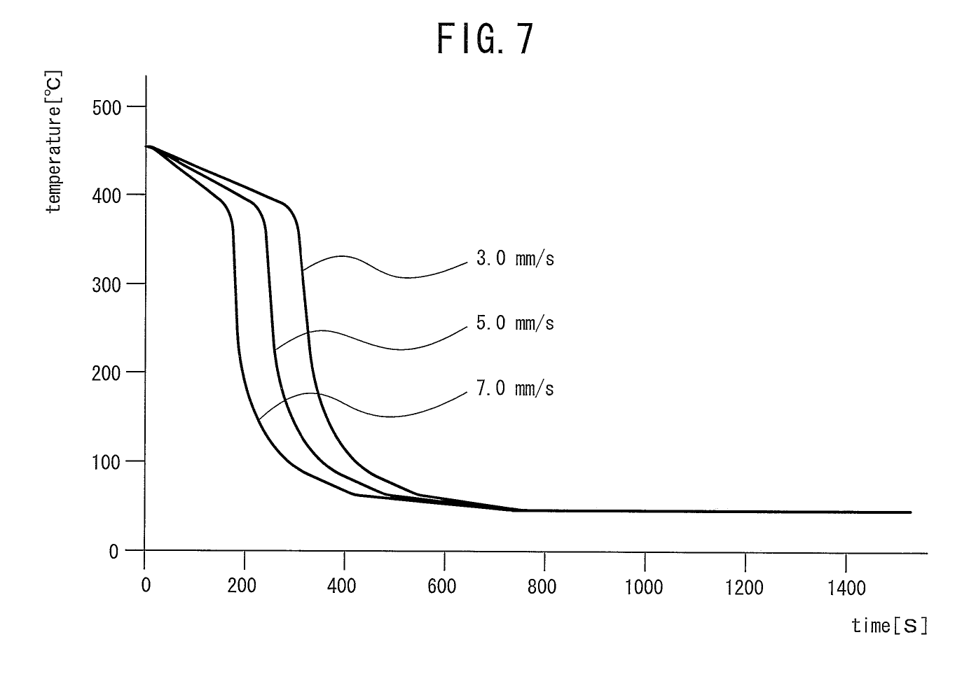

The temperature information storing section 33b stores information on a relationship among the temperature of the outer surface 81b immediately before quenching, the water level ascent velocity of the quenching water 93, the thickness of the coke 92 adhering to the inner surface 81a, and the change in the temperature of each division 81c of the sidewall portion 81. The temperature information storing section 33b stores relationship information for various conditions (for example, in addition to the temperature of the outer surface 81b immediately before quenching, the water level ascent velocity of the quenching water 93 and the thickness of the coke 92 adhering to the inner surface 81a, the thickness of the sidewall portion 81 and/or the material of the sidewall portion 81) based on results of experiments and calculation results obtained from the experiments results. As illustrated in FIG. 7, the change in the temperature of the outer surface 81b and the water level ascent velocity of the quenching water 93 are in a relationship in which the water level ascent velocity is higher, the change in the temperature (temperature decrease velocity) of the outer surface 81b is faster. The graph illustrated in FIG. 7 indicates the change in the temperature of the outer surface 81b in each of cases where the thickness of the coke 92 adhering to the inner surface 81a is 0.0 mm and the water level ascent velocity is 3.0 mm/s, 5.0 mm/s and 7.0 mm/s, respectively.

The temperature change calculating section 33c calculates change in the temperature of each division 81c of the sidewall portion 81 quenched by the quenching water 93, based on the water level ascent velocity of the quenching water 93 detected by the water level detecting section 31, the thickness of the coke 92 calculated by the thickness calculating section 32 and the information stored in the temperature information storing section 33b. In the present embodiment, the temperature change calculating section 33c recognizes the heating temperature (set temperature) of the raw oil 91 input via the input section 23 as the temperature of the outer surface 81b immediately before quenching. The calculation is performed considering the temperature of the quenching water 93 as 100° C. where the temperature of the sidewall portion 81 exceeds 100° C.

Referring back to FIG. 3, the strain calculating device 34 includes a strain information storing section 34a that stores information on a relationship between the change in the temperature of each division 81c of the sidewall portion 81 and a strain in each division 81c, and a strain change calculating section 34b that calculates change in the strain in each division 81c of the sidewall portion 81 based on the change in the temperature of the division 81c of the sidewall portion 81 calculated by the temperature calculating section 33 and the information in the strain information storing section 34a.

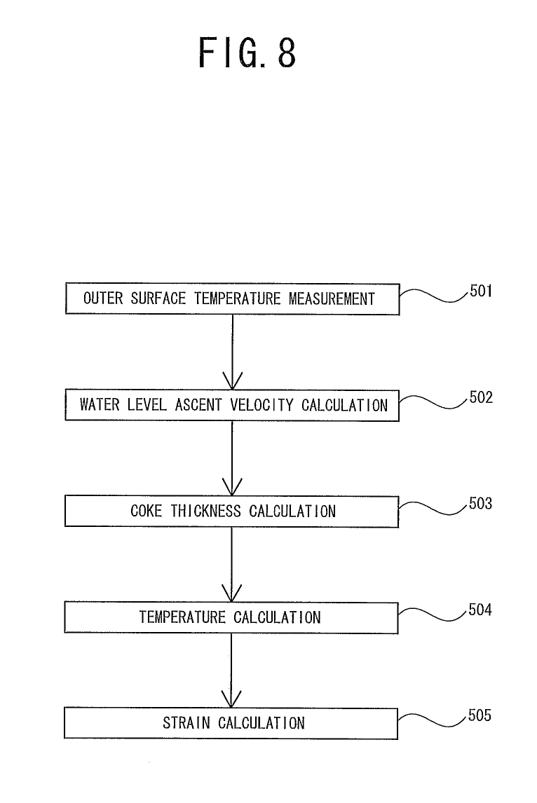

The configuration of the analysis apparatus according to the present embodiment has been described above, and next, an analysis method according to the present embodiment will be described with reference to FIG. 8. Here, description is provided below only on an analysis method in a quenching process.

In an outer surface temperature measurement step 501, each temperature measuring device 21a measures change in the temperature of the outer surface 81b of the sidewall portion 81, and the method proceeds to a water level ascent velocity calculation step 502.

In the water level ascent velocity calculation step 502, the arrival time calculating section 31a performs calculation to average times at which the temperatures measured by respective temperature measuring devices 21a arranged in a same height position started decreasing and set the resulting average time as a time at which the quenching water 93 arrived at the height position. The ascent velocity calculating section 31b calculates the water level ascent velocity of the quenching water 93, based on a difference between the quenching water arrival times at respective height positions calculated by the arrival time calculating section 31a and distances between the respective height positions. After the water level detecting section 31 detects the water level ascent velocity of the quenching water 93 supplied into the coke drum 8 as described above, the method proceeds to a coke thickness calculation step 503.

In the coke thickness calculation step 503, the thickness determining section 32b determines a thickness of the coke 92 adhering to the inner surface 81a of the sidewall portion 81, based on change in the temperature of the outer surface 81b of the sidewall portion 81 measured by each temperature measuring device 21a and the information stored in the thickness information storing section 32a. Then, after the thickness calculating section 32 calculates the thickness of the coke 92 adhering to the inner surface 81a of the sidewall portion 81, the method proceeds to a temperature calculation step 504.

In the temperature calculation step 504, the sidewall dividing section 33a divides the sidewall portion 81 into a plurality of divisions in the thickness direction and the height direction, respectively. The temperature change calculating section 33c calculates change in the temperature of each of divisions 81c including the inner surface 81a of the sidewall portion 81, based on the temperature of the outer surface 81b immediately before quenching detected by the temperature detecting section 21, the water level ascent velocity of the quenching water 93 detected by the water level detecting section 31, the thickness of the coke 92 calculated by the thickness calculating section 32 and information stored in the temperature information storing section 33b. Then, after the temperature calculating section 33 calculates the change in the temperature of the inner surface 81a of the sidewall portion 81, the method proceeds to a strain calculation step 505.

In the strain calculation step 505, the strain change calculating section 34b calculates change in a strain in each of the divisions 81c including the inner surface 81a of the sidewall portion 81, based on the change in the temperature of the inner surface 81a of the sidewall portion 81 calculated by the temperature calculating section 33 and the information stored in the strain information storing section 34a. As described above, highly-accurate data on the change in the temperature of the inner surface 81a and/or highly-accurate data on the change in strain can be obtained.

In the temperature calculation step 504 and/or the strain calculation step 505, calculation of temperature change and/or strain change can be performed not only for the divisions 81c including the inner surface 81a of the sidewall portion 81, but also for divisions 81c including the outer surface 81b of the sidewall portion 81 and/or divisions 81c in an inner part of the sidewall portion 81.

Furthermore, data on a strain at a predetermined position in the outer surface 81b measured by the strain measuring device 22a and data on a strain calculated by the strain calculating device 34 based on change in the temperature at the predetermined position of the outer surface 81b measured by the temperature measuring device 21a may be compared with each other to verify the accuracy of the obtained temperature data and/or strain data.

As described above, in the coke drum analysis apparatus 1 according to the present embodiment, the temperature detecting section 21 detects a temperature of the outer surface 81b of the sidewall portion 81 of the coke drum 8. The water level detecting section 31 detects a water level ascent velocity of the quenching water 93 supplied into the coke drum 8. The thickness calculating section 32 calculates a thickness of coke 92 adhering to the inner surface 81a of the sidewall portion 81 based on change in the temperature of the outer surface 81b of the sidewall portion 81 detected by the temperature detecting section 21 and the water level ascent velocity of the quenching water 93 detected by the water level detecting section 31. The temperature calculating section 33 calculates change in a temperature of the inner surface 81a of the sidewall portion 81 quenched by the quenching water 93, based on the water level ascent velocity detected by the water level detecting section 31 and the thickness of the coke 92 calculated by the thickness calculating section 32. Accordingly, data on the calculated change in the temperature of the inner surface 81a is one obtained taking the thickness of the coke 92 and the water level ascent velocity of the quenching water 93 into consideration, and thus, is highly-accurate analysis data. Thus, the accuracy of estimation of fatigue damage of the sidewall portion 81 of the coke drum 8 can be enhanced.

Furthermore, in the coke drum analysis apparatus 1 according to the present embodiment, the temperature detecting section 21 includes a plurality of temperature measuring devices 21a that each measures a temperature of the outer surface 81b of the sidewall portion 81. The plurality of temperature measuring devices 21a measures temperatures at height different positions of the outer surface 81b of the sidewall portion 81, the height different positions being spaced from each other in the height direction of the coke drum 8. The ascent velocity calculating section 31b in the water level detecting section 31 calculates a water level ascent velocity of the quenching water 93 based on a difference between times at which the temperatures measured by the respective temperature measuring devices 21a started decreasing. Thus, the temperature measuring device 21a can be used also as a water level velocity measuring device.

Furthermore, in the coke drum analysis apparatus 1 according to the present embodiment, the plurality of temperature measuring devices 21a measure temperatures at circumferentially different positions of the outer surface 81b of the sidewall portion 81, the circumferentially different positions being at a same height position in the coke drum 8 and being spaced from each other in the circumferential direction of the coke drum 8. The arrival time calculating section 31a in the water level detecting section 31 calculates a time at which the quenching water 93 arrived at the height position, based on the times at which the temperatures measured by the respective temperature measuring devices 21a started decreasing. Thus, the time at which the quenching water 93 arrived at the height position can be calculated accurately.

Furthermore, in the coke drum analysis apparatus 1 according to the present embodiment, the temperature calculating section 33 divides the sidewall portion 81 into a plurality of divisions in the thickness direction and the height direction, respectively, and calculates change in a temperature of each division 81c of the divided sidewall portion 81. Thus, data on change in a temperature at any position of the sidewall portion 81 can be obtained.

Furthermore, in the coke drum analysis apparatus 1 according to the present embodiment, the strain calculating device 34 calculates a strain in the inner surface 81a of the sidewall portion 81 based on the change in the temperature of the inner surface 81a of the sidewall portion 81 calculated by the temperature calculating section 33. Thus, highly-accurate data on the strain in the inner surface 81a of the sidewall portion 81 can be obtained.

It should be understood that the coke drum analysis apparatus and method according to the present invention is not limited to the above-described embodiment and various alterations can be made without departing from the scope and spirit of the present invention. Also, it should be understood that any of configurations and/or methods, etc., according to various alternations described below can arbitrarily be selected and employed in the configuration and/or method, etc., according to the above-described embodiment.

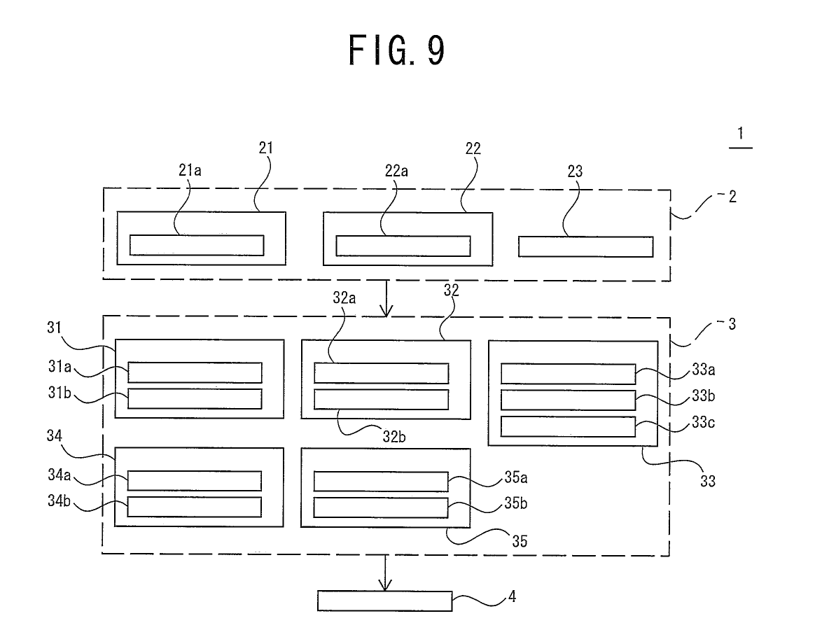

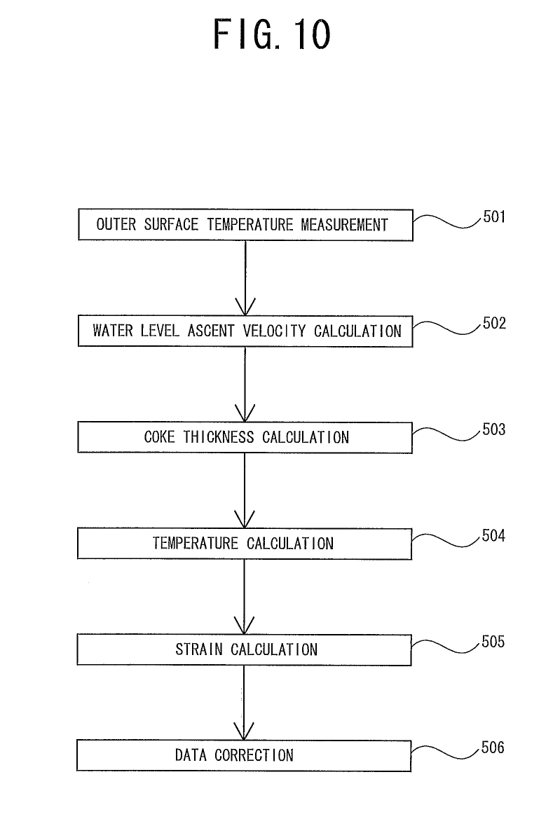

For example, the coke drum analysis apparatus 1 and the coke drum analysis method according to the present invention, as illustrated in FIGS. 9 and 10, may further include a data correction section 35 that corrects data on a strain in the inner surface 81a calculated by the strain calculating device 34.

The data correction section 35 includes a comparison and verification section 35a that performs verification by comparing data on a strain at a predetermined position in the outer surface 81b measured by the strain measuring device 22a and data on a strain at the predetermined position in the outer surface 81b calculated by the strain calculating device 34 based on the temperature at the predetermined position of the outer surface 81b measured by the temperature measuring device 21a, and a correction performing section 35b that if the comparison and verification section 35a determines that data correction is needed, corrects data on a strain in the inner surface 81a calculated by the strain calculating device 34.

With the analysis apparatus 1 having such configuration, in a data correction step 506 performed after the strain calculating step 505, the comparison and verification section 35a performs verification by comparing data on a strain in the outer surface 81b measured by the strain measuring device 22a and data on a strain in the outer surface 81b calculated by the strain calculating device 34. If the comparison and verification section 35a determines that data correction is needed, the correction performing section 35b corrects data on a strain in the inner surface 81a calculated by the strain calculating device 34.

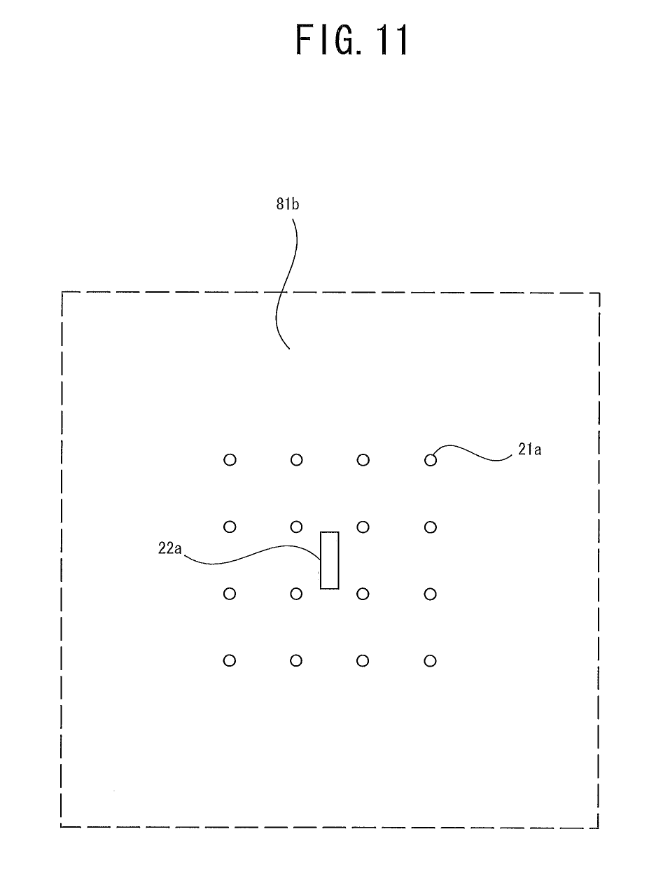

Furthermore, although the coke drum analysis apparatus 1 and the coke drum analysis method according to the above embodiment has been described in terms of a configuration in which the strain measuring device 22a measures a strain at a position where a temperature measuring device 21a measures a temperature, the present invention is not limited to such configuration. For example, as illustrated in FIG. 11, the strain measuring device 22a may be configured to measure a strain at a position different from a position where the temperature measuring devices 21a each measures a temperature.

In the analysis apparatus 1 having such configuration, in order to correct data, in the temperature calculating step 504, the temperature calculating section 33 calculates change in a temperature at a measuring position of the outer surface 81b where a strain is measured by the strain measuring device 22a, and in the strain calculating step 505, the strain calculating device 34 calculates a strain at the measuring position of the outer surface 81b based on the change in the temperature at the measuring position of the outer surface 81b calculated by the temperature calculating section 33.

Furthermore, although the coke drum analysis apparatus 1 and the coke drum analysis method according to the above embodiment has been described in terms of a configuration in which the water level detecting section 31 calculates a water level ascent velocity of the quenching water 93 based on data on temperatures measured by the respective temperature measuring devices 21a, that is, a configuration in which the temperature measuring device 21a is used also as a water level velocity measuring device, the present invention is not limited to such configuration. For example, it is possible that the water level detecting section 31 includes a water level velocity measuring device (pressure sensor) that measures an inner pressure (that is, a water pressure proportional to a height of a water level), at a bottom portion of the coke drum 8 to calculate a water level ascent velocity of the quenching water 93 based on data on the pressure measured by the water level velocity measuring device.

Furthermore, although the above embodiment has been described in terms of a configuration in which the temperature change calculating section 33c recognizes a heating temperature (set temperature) of the raw oil 91 input via the input section 23 as a temperature of the outer surface 81b immediately before quenching, the present invention is not limited to such configuration. For example, it is possible to configure the temperature change calculating section 33c to recognize a temperature of the outer surface 81b immediately before quenching detected by the temperature detecting section 21 as a temperature of the outer surface 81b immediately before quenching.

Furthermore, although the coke drum analysis method according to the above embodiment has been described in terms of a configuration in which the processor 3 calculates a water level ascent velocity of the quenching water 93, a thickness of the coke 92 adhering to the inner surface 81a, temperatures of the respective divisions 81c, and strains in the respective divisions 81c, the present invention is not limited to such method. For example, an analysis method in which an operator calculates at least one of the water level ascent velocity of the quenching water 93, the thickness of the coke 92 adhering to the inner surface 81a, the temperatures of the respective divisions 81c and the strains in the respective divisions 81c, by means of comparison with any of various types of information.

The coke drum analysis apparatus and method according to the present invention enables obtainment of highly-accurate data on change in a temperature of an inner surface, and thus, can be utilized for estimation of fatigue damage of a sidewall portion of a coke drum.

1. A coke drum analysis apparatus for analyzing change in a sidewall portion of a coke drum having a cylindrical shape, the apparatus comprising:
a temperature detecting section that detects a temperature of an outer surface of the sidewall portion;
a water level detecting section that detects a water level ascent velocity of quenching water supplied into the coke drum;
a thickness calculating section that calculates a thickness of coke adhering to an inner surface of the sidewall portion based on change in the temperature of the outer surface of the sidewall portion detected by the temperature detecting section and the water level ascent velocity of the quenching water detected by the water level detecting section; and
a temperature calculating section that calculates change in a temperature of the inner surface of the sidewall portion quenched by the quenching water, based on the water level ascent velocity detected by the water level detecting section and the thickness of the coke calculated by the thickness calculating section.

2. The coke drum analysis apparatus according to claim 1, wherein:
the temperature detecting section includes a plurality of temperature measuring devices that each measures a temperature of the outer surface of the sidewall portion;
the plurality of temperature measuring devices measure temperatures at positions of the outer surface of the sidewall portion, the positions being spaced from each other in a height direction of the coke drum; and
the water level detecting section includes an ascent velocity calculating section that calculates the water level ascent velocity of the quenching water based on a difference between times at which the temperatures measured by the respective temperature measuring devices started decreasing.

3. The coke drum analysis apparatus according to claim 2, wherein:
the plurality of temperature measuring devices measure temperatures at positions of the outer surface of the sidewall portion, the positions being at a same height position of the coke drum and being spaced from each other in a circumferential direction of the coke drum; and
the water level detecting section includes an arrival time calculating section that calculates a time at which the quenching water arrived at the height position, based on the times at which the temperatures measured by the respective temperature measuring devices started decreasing.

4. The coke drum analysis apparatus according to claim 1, wherein the temperature calculating section divides the sidewall portion into a plurality of divisions in a thickness direction and the height direction, respectively, and calculates change in a temperature of each division of the divided sidewall portion.

5. The coke drum analysis apparatus according to claim 1, further comprising a strain calculating device that calculates a strain in the inner surface of the sidewall portion based on the change in the temperature of the inner surface of the sidewall portion calculated by the temperature calculating section.

6. The coke drum analysis apparatus according to claim 5, further comprising:
a strain measuring device that measures a strain at a predetermined position in the outer surface of the sidewall portion, a temperature at the predetermined position of the outer surface being detected by the temperature detecting section; and
a data correction section that corrects data on the strain in the inner surface calculated by the strain calculating device,
wherein the strain calculating device calculates a strain at the predetermined position in the outer surface, based on change in the temperature at the predetermined position of the outer surface detected by the temperature detecting section; and
wherein the data correction section corrects the data on the strain in the inner surface calculated by the strain calculating device, based on data on the strain at the predetermined position in the outer surface measured by the strain measuring device and data on the strain at the predetermined position in the outer surface calculated by the strain calculating device.

7. The coke drum analysis apparatus according to claim 5, further comprising:
a strain measuring device that measures a strain at a predetermined position in the outer surface of the sidewall portion; and
a data correction section that corrects data on the strain in the inner surface calculated by the strain calculating device,
wherein the temperature calculating section calculates change in a temperature at the predetermined position of the outer surface of the sidewall portion;
wherein the strain calculating device calculates a strain at the predetermined position in the outer surface, based on the change in the temperature at the predetermined position of the outer surface calculated by the temperature calculating section; and
wherein the data correction section corrects data on the strain in the inner surface calculated by the strain calculating device, based on data on the strain at the predetermined position in the outer surface measured by the strain measuring device and data on the strain at the predetermined position in the outer surface calculated by the strain calculating device.

8. A coke drum analysis method for analyzing change in a sidewall portion of a coke drum having a cylindrical shape, the method comprising:
detecting a temperature of an outer surface of the sidewall portion;
detecting a water level ascent velocity of quenching water supplied into the coke drum;
calculating a thickness of coke adhering to an inner surface of the sidewall portion based on change in the detected temperature of the outer surface of the sidewall portion and the detected water level ascent velocity of the quenching water; and
calculating change in a temperature of the inner surface of the sidewall portion quenched by the quenching water, based on the detected water level ascent velocity of the quenching water and the calculated thickness of the coke.
